(19) United States
(12) Patent Application Publication
(10) Pub. No.: US 2026/0234823 A1
(43) Pub. Date: Aug. 13, 2026

(54) ARRANGEMENT FOR GAS-LIQUID SEPARATION AND USE THEREOF

(71) Applicant: Siemens Energy Global GmbH & Co. KG, München (DE)

(72) Inventors: Erik Wolf, Röttenbach (DE); Christian Reller, Minden (DE)

(21) Appl. No.: 19/160,560

(22) PCT Filed: Jan. 4, 2024
(86) PCT No.: PCT/EP2024/050123

§ 371 Date: Aug. 28, 2025

(30) Foreign Application Priority Data
Feb. 28, 2023 (DE) 10 2023 201 802.0

(51) Int. Cl. C25B 15/08; B01D 45/16; C25B 1/04; C25B 15/023

(52) U.S. Cl. CPC C25B 15/08; B01D 45/16; C25B 1/04; C25B 15/023

(57) ABSTRACT

An arrangement for gas-liquid separation includes first and second gas separators for first and second gases, each having one vessel. The vessels have either the same or a different vessel volume, are in hydraulic communicating connection for a liquid via a connecting conduit and are at the same height. The operational configuration is such that a predefined standard fill level of the liquid is established when the pressure in the vessels is equal, and so a liquid volume is provided at the standard fill level, the vessel volume is composed of the liquid volume and the corresponding gas volume, and the liquid volume in the vessels is greater than the corresponding gas volume. A method of operating an electrolyzer, in particular in safe operation of an electrolysis plant with an electrolyzer for alkaline electrolysis, and an electrolysis plant, are also provided.

The invention relates to an arrangement for gas-liquid separation having a first gas separator for a first gas and a second gas separator for a second gas that each have a vessel. The invention further relates to the use of such an arrangement, in particular for safe operation of an electrolysis plant.

At present—driven by climate change—there are considerable efforts to cover the largest possible share of society's total energy needs from renewable energy sources. For instance, the Federal Government of the Federal Republic of Germany in 2010 agreed an energy concept which, among other measures, envisages a share of renewable energies of 80% of gross electricity consumption by 2050. In 2017, that share was 36%. A large portion thereof (24.2%) was generated by wind turbines on land and sea, and by photovoltaic systems. However, wind power and photovoltaic systems in particular are highly dependent on weather conditions and/or fluctuations in insolation according to the time of day and year. Thus, power generation by these systems is not guided by current demand, but by the current environmental conditions. As a result, there is a need for energy storage technologies in order to compensate for these differences.

The electrochemical production of hydrogen from water constitutes such a storage technology since, in this way, unusable electrical energy, for example from temporary over-production, can be chemically bound in hydrogen, stored, transported and released again for use elsewhere. One field of intensified research activity has therefore been in electrolyzers for water electrolysis for this purpose. One possible technology path for water electrolysis is, for example, PEM electrolysis (PEM: “polymer electrolyte membrane”, also known as “proton exchange membrane”) of water. In such PEM electrolyzers, the hydrogen produced is typically obtained in a two-phase stream with recirculated water, from which it first has to be separated before being sent to further use. Another type of electrolysis of water is alkaline electrolysis, in which, for example, potassium hydroxide KOH is supplied to the electrolyzer in concentrated aqueous solution as reactant. Additionally known are high-temperature and high-pressure electrolyses.

Common processes in the context of electrolysis are in particular mechanical processes for gas-liquid separation, which are conducted by means of gas separators. The separation of gas-liquid mixtures is a sorting process, since it is based on the physical properties of the phases. The separation mechanisms for particles in the separation processes can be roughly divided into two groups: separation in force fields and separation on filters. Since the densities of gases and liquids differ by orders of magnitude of up to 10⁴ (for hydrogen), density is the most important separating feature for this process step.

For this reason, mass forces in the field of gravity and centrifugal field are often considered and exploited in a targeted manner as an operating principle for phase separation in the gas separator. Filtering separators, by contrast, are based on the exploitation of forces of inertia that are effective in the case of single or multiple flow deflection.

In the interconnecting of gas separators in a plant to form an arrangement of gas-conducting vessels with reactive gases, it is necessary in particular to avoid what is called breakthrough of the gases. Mixing of gases having a tendency to react with one another in one of the vessels in an arrangement can lead to an acute explosion risk. This is particularly problematic, for example, in the case of water electrolyses, where uncontrolled transfer from hydrogen to oxygen or vice versa has to be avoided. Therefore, even in normal operation of an electrolyzer, extraneous gas concentration in the vessels of the gas separators is continuously monitored, i.e. the concentration of oxygen in hydrogen or the concentration of hydrogen in oxygen. A problematic situation is when a power failure or an external fault leads to a risk of abrupt and uncontrolled gas transfer.

It is therefore an object of the invention to provide an arrangement for gas-liquid separation with two gas-conducting vessels. The arrangement is to be improved in terms of safety and emergency shutdown characteristics, while avoiding breakthrough in the event of a gas leak and an explosive gas mixture of two involved gases.

This object is achieved in accordance with the invention by an arrangement for gas-liquid separation with a first gas separator for a first gas and a second gas separator for a second gas that each have a vessel, wherein the vessels have a vessel volume and the vessels are in hydraulic communicating connection for a liquid via a connecting conduit and are at the same height, wherein an operational design is envisaged such that a predefined standard fill level of the liquid is established when the pressure in the vessels is equal, and so a liquid volume is provided at the standard fill level, wherein the vessel volume is composed of the liquid volume and the corresponding gas volume, and wherein the liquid volume in the vessels is greater than the corresponding gas volume.

The invention proceeds from the finding that existing safety concepts for gas-conducting vessels in an industrial plant, for instance gas separators of electrolysis plants, are only insufficiently protected against highly hazardous safety-relevant situations in the event of a failure of the supply system, for instance the power supply, or as a result of unforeseen external harmful effects. This relates particularly to uncontrolled escape of gas from a vessel and the risk of explosion on mixing of reactive gases.

With the arrangement of the invention, an intrinsic safety system is proposed, which achieves effective breakthrough protection for the gases and hence effectively counteracts mixing and the risk of explosion.

The arrangement comprises at least two vessels in which a gas-liquid mixture can be separated gravimetrically, which are connected to one another via the liquid phase in operation of the arrangement. These are gas separators that each have a vessel with a vessel volume. These are connected downstream of a preceding process, in particular water electrolysis, in which two different gases that can react with one another are formed. As a result of the process, the gases are embedded in a liquid phase (working medium) on exit from the process and pass through said gas separators (gas-liquid separators). The process requires a connection between the two liquid phases in order to function efficiently and permanently. Therefore, the connecting conduit is provided, which connects the vessels in hydraulic communication for the liquid. The connecting conduit serves to compensate for slightly different volume flow rates as a result of the upstream process and/or to compensate for a concentration gradient. The vessels advantageously have a respective vessel volume, where the vessel volumes may be either identical or different depending on the application in a system. In the case of identical vessel volumes, a standard component is available for one vessel, which can be used for both the first gas separator and for the second gas separator. This is an advantage in terms of manufacturing. One of the vessels or else optionally both vessels may also contain, if required, a device capable of partly or fully expelling the gas dissolved in the liquid.

Both subsystems of the arrangement that are formed by the two vessels are designed and operable for the same or virtually the same pressure conditions in operation, i.e. a design pressure or working pressure. The pressure differential that arises in the connected vessels via the gas separators must not lead to the breakthrough of the gaseous phase through the connecting conduit via the liquid phase, otherwise a serious and highly dangerous safety-relevant situation may occur. Development of this situation must be avoided under all circumstances.

This is the starting point for the intrinsic safety concept of the invention, in that this is already taken into account a priori in the design and arrangement and is implemented in the arrangement by the two communicating vessels that form the gas separators and are preferably of equal volume. It is a feature of the design that a predefined standard fill level of the liquid is established when the pressure in the vessels is equal, and so a liquid volume is provided at the standard fill level, wherein the vessel volume is composed of the liquid volume and the corresponding gas volume, and wherein the liquid volume in the vessels under standard conditions is greater than the corresponding gas volume. In particular, this achieves the effect that the liquid volume of one vessel in a normal operating situation is always greater than the gas volume of the other vessel.

This design concept of the invention advantageously achieves the effect in the vessel arrangement that the design fill level in the vessels is adjustable and controllable from a safety point of view such that the gas volume in the gas separator is always smaller than the liquid volume. For this purpose, the arrangement preferably has a fill level controller which provides closed-loop control to the predefined standard fill level in the vessels, such that the volume condition for the minimum liquid volume required is fulfilled, in particular under the standard conditions under equal pressure conditions. In this normal operating situation, the pressure differential between the vessels is zero or very small or varies within a permissible margin.

If there is then a significant pressure differential situation between the vessels communicating via the connecting conduit, it is ensured that liquid from one (first) vessel can overflow into the other (second) vessel. This liquid completely displaces the gas phase in this vessel which is initially above the liquid at the standard fill level before the gas in one vessel can pass into the other vessel via the connecting conduit. Mixing of the first gas with the second gas as a result of a gas transfer or gas breakthrough is prevented, and hence the formation of a reactive and possibly even explosive gas mixture is ruled out.

Compared to known compressed gas-conducting and connected vessels in gas separators, this intrinsic safety concept of the invention is superior and very advantageous. These include active closed-loop control systems and safety shutdowns of the upstream process, for example an electrochemical decomposition of water to oxygen and hydrogen in an electrolyzer. In installed systems, for example, this is currently actively controlled via complex regulation and control of the fill levels (Δh~Δp) shifted by the pressure differential between the communicating vessels. If the difference in fill level exceeds a certain permissible value, the upstream process in the system—such as an electrolysis process—has to be shut down in line with safety. If, on the other hand, the fault is actually the result of external action, for instance resulting from a break in a gas-discharging conduit or failure of a pressure regulator or pressure differential regulator on the part of one of the two vessels, the measure of “shutting down the upstream process” will not be capable of gaining control of the operating situation, in particular a sudden gas breakthrough with acute risk of explosion.

In a particularly preferred configuration of the arrangement, the standard fill level of the two vessels, the liquid volume is greater than the gas volume by at least 10%, in particular by 15% to 30%.

It has been shown that this design provides a sufficient safety margin for a difference between the liquid volume and the gas volume at the standard fill level. Thus, a sufficiently large gas volume of that in the communicating vessels, for instance, is available for the gas-liquid separation process in normal operation of the arrangement. In any case, it should be noted that, under design conditions in both vessels, the liquid volume—and hence the standard fill level in the vessels—is greater in each case than the gas volume in the other vessel. For example, liquid volumes under design conditions between about 53% to 56% of the vessel volume have been found to be advantageous. Depending on the design, a sufficient gas volume in the vessels of 47% to 44% is accordingly thus available in normal operation.

In a preferred configuration of the arrangement, this is designed for normal operation at a design pressure with a pressure differential of less than or equal to 100 mbar between the gas phases in the vessels.

This means that a mode of operation in normal operation with a small pressure differential between the communicating vessels as a control variance from the design pressure is provided. If possible, however, operation at equal pressure is preferred, i.e. the vessels are operated at the same or almost the same pressure and the arrangement is designed accordingly. The permissible pressure differential of up to about 100 mbar advantageously enables a certain operating flexibility in a small permissible pressure differential interval and in each case an almost steady-state and stable mode of operation of the arrangement in this range.

In a further-preferred configuration of the invention, a gas separator has a valve which is activatable by a float device disposed on top of the vessel at its gas outlet, such that, in the event of a high pressure differential above a maximum permissible pressure differential, liquid is prevented from exiting from a gas separator or the volume flow rate is throttled to a set value. In addition to a mechanical design, the float device can preferably also be designed as an electrical or electromechanical device, such that an electrical fill level measurement with a fill level signal and activation of the valve is then implemented.

The float device is preferably therefore equipped with an electrical fill level measuring device that can bring about electrical activation of the valve. The float device can also be designed as a purely electrical fill level measuring device or as an electromechanical fill level measuring device.

In this way, an advantageous and additional safety measure for the breakthrough protection is proposed, whereby the upper outlet regions of the vessels are equipped, by means of a float valve or an automatic ventilation known from plant construction, such that the outlet is blocked or optionally throttled after the gas phase has flowed out or been displaced completely, in order to prevent or distinctly slow the flow of the liquid phase out of the vessel.

It has been found from first estimates for a design that a valve configured as a throttle valve should preferably be provided, with which, when the throttle valve is activated, the volume flow rate of the liquid can be reduced to less than 50%, in particular less than 20%.

More preferably, an electrical fill level measurement is implemented in the float device and a combination with an activatable valve or with an activatable throttle valve is envisaged.

The throttle effect of the throttle valve is preferably adjustable to the operating situation, and the expected volume flow rates to the demand. A complete occlusion and shut-off effect can therefore also be provided. It is preferable that further process engineering units and components at the outlet of the arrangement with additional dead volumes or residual volumes can likewise be included and are taken into account in the determination of the volume condition for the liquid.

In a particularly preferred configuration of the arrangement, the latter has at least one cyclone separator, or cyclone separator with recombiner, downstream of the gas separators at the gas outlet, such that, in the event of a breakthrough of the gas out of a vessel, phase separation of liquid and gas can be brought about outside the gas separator.

With this additional safety measure, it is possible to separate a gas-liquid mixture that exits via the throttle valve into the liquid phase and the gaseous phase and sent to separate treatment. Uncontrolled exit of potentially damaging or explosive gases is avoided. For example, in an alkaline water electrolysis, an exiting phase mixture of liquid alkali with hydrogen can be separated in the downstream cyclone separator, such that the remaining hydrogen from the vessel as product gas and the alkali can be secured, stored and reused. For this purpose, it is advantageously possible to specially provide a respective storage vessel into which the liquid can be introduced and collected as a precaution in an emergency situation.

The cyclone separator is a flow component which in particular does not require any kind of electrical or other supply or operating media. The cyclone separator imparts a tangential movement component to the product gas stream flowing in an axial direction in the phase mixture or the mixture of product gas and liquid, and the product gas stream is thus brought onto a circular path. Radial forces acting radially inward toward the z axis and reduction of the radial component result in an increase in the speed of rotation to such an extent that the heavier water particles are spun outward as a result of the centrifugal force and slowed down. The lighter product gas, on the other hand, is conveyed and transported into the inner region in the axially central zone, and separated out.

A collecting vessel which is preferably provided in the arrangement is downstream of a cyclone separator, such that liquid separated off in the cyclone separator can be introduced into the collecting vessel. In this case, a respective collecting vessel may preferably be connected downstream of a vessel.

On the gas outlet side, there is preferably a cyclone separator for separation of the gas-liquid phase which would be reestablished when the gas breaks through, but cannot be separated within the gas separator. This is because of the excessively high volume flow rate and the excessively short dwell time after exit. The phase separation is advantageously effected outside by virtue of the provision made with the cyclone separator. The liquid phase separated off thereby can be collected and secured by the collecting vessel(s) as an emergency vessel, such that, even in the event of an accident, uncontrolled exit and loss can be avoided.

A further aspect of the invention is the advantageous use of the arrangement in process engineering for gas-conducting systems with phase separation devices for gas-liquid separation (gas separators), which is significantly improved by the implementation of the arrangement in the plant design with regard to plant safety and explosion protection.

In the inventive use of the arrangement, the fill level in a vessel is adjusted to a standard fill level, wherein gas transfer between the vessels is prevented in the case of a high pressure differential above a maximum permissible pressure differential, so as to stop the first gas from mixing with the second gas.

In the case of this use, the arrangement advantageously has an upstream industrial plant comprising a conversion process, from which a first gas and a second gas in a respective phase mixture composed of a liquid and the first gas or the second gas is produced, for instance an electrolysis process for electrochemical decomposition of an electrolyte solution as reactant.

In the use, an electrolyzer is preferably supplied with a liquid as reactant and the product gases produced are hydrogen as first gas and oxygen as second gas by electrochemical decomposition in a respective phase mixture, and wherein a gas-liquid separation of the product gases is conducted in the gas separators.

In a preferred use, the electrolyzer is supplied with an alkaline aqueous solution as reactant, in particular potassium hydroxide (KOH) in an aqueous solution with a concentration of 20%-40%.

A further aspect of the invention is the preferred integration of the arrangement into an electrolysis plant.

Accordingly, an electrolysis plant with an electrolyzer for production of hydrogen and oxygen as product gases is proposed, comprising an arrangement, wherein the electrolyzer is connected to the connecting conduit of the arrangement, and wherein the electrolyzer is connected to the first gas separator via a first product flow conduit for hydrogen and to the second gas separator via a second product flow conduit for oxygen.

As a result, an operational safety concept is implemented in an electrolysis plant, so that gas breakthrough and gas transfer are already intrinsically ruled out by the plant design. Risk of an explosion through mixing of reactive gases is thus also avoided. The electrolyzer is connected on the reactant side to the connecting conduit of the arrangement such that a reactant liquid, for example an alkaline aqueous solution, is available in operation in the anode chamber and in the cathode chamber of the electrolysis cell or flows through these reaction chambers. Moreover, fresh reactant liquid can be fed continuously to the electrolyzer via a supply conduit in order to compensate for the consumption of water or electrolyte solution in operation.

In a further-preferred configuration of the electrolysis plant, the electrolyzer is configured as an alkaline electrolyzer and has a diaphragm which selectively (with respect to the diaphragm) allows transfer of hydroxide ions, such that an alkaline electrolysis is performable.

In the alkaline electrolyzer, hydrogen is formed at the cathode and oxygen is formed at the anode at a DC voltage of at least 1.5 volts. The electrolyte used is potassium hydroxide solution (KOH) with a concentration of typically 20%-40%. The ion-permeable membrane used is a largely gas-tight membrane, called the diaphragm. Although this allows the transport of OH⁻ ions, it simultaneously prevents mixing of the product gases formed. Electrodes used are “DSA electrodes” (dimensionally stable anodes), usually titanium electrodes with a ruthenium oxide coating. These are expanded metals that are coated with a precious metal catalyst oxide—e.g. ruthenium oxide or iridium oxide. But there are also systems comprising Raney nickel catalysts in a gas diffusion electrode. Alkaline electrolyzers are used on a large scale globally.

Further advantages, features and details of the invention will be apparent from the description of the preferred working examples that follows, and from the drawing. The features and combinations of features cited above in the description and the features and combinations of features cited below in the description of the figures and/or shown on their own in the individual figures are usable not just in the respectively specified combination but also in other combinations or on their own, without departing from the scope of the invention.

Working examples of the invention are now elucidated in detail by a drawing. These show, in schematic and highly simplified form:

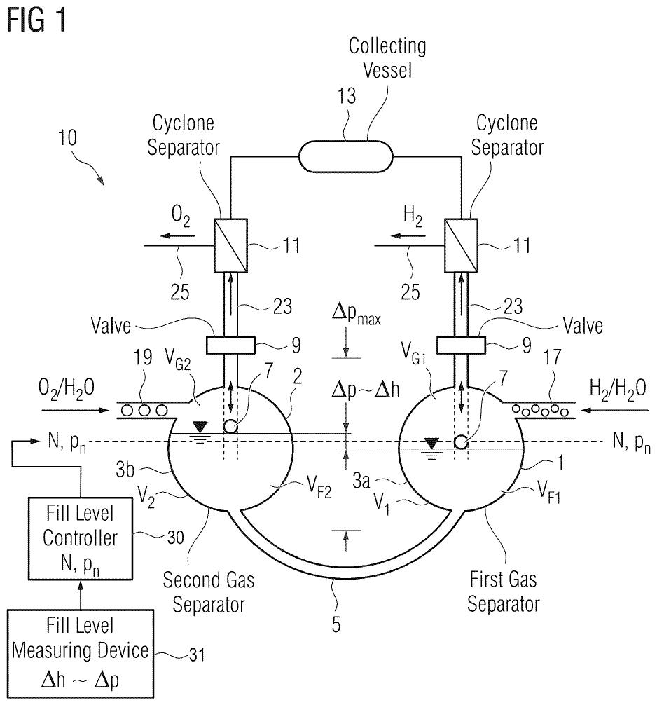

FIG. 1 an arrangement for gas-liquid separation with two vessels,

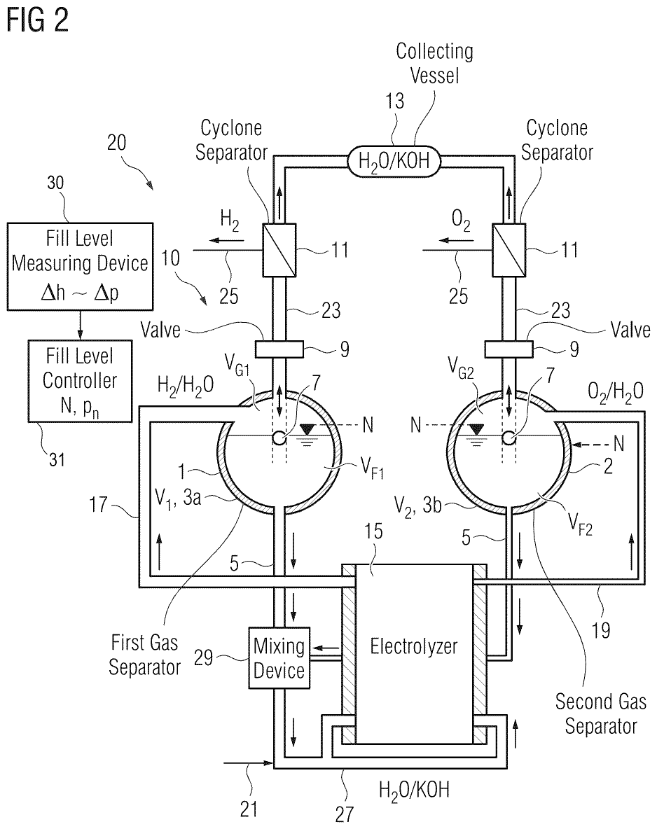

FIG. 2 an electrolysis plant with an electrolyzer and with an arrangement according to FIG. 1.

Identical reference symbols have the same meaning in the figures.

FIG. 1 shows an arrangement 10 for gas-liquid separation with a first gas separator 1 for a first gas and a second gas separator 2 for a second gas. The first gas separator 1 has a vessel 3a with a vessel volume V₁, and the second gas separator 2 correspondingly has a vessel 3b with a vessel volume V₂. The vessel volumes V₁, V₂ of the two vessels 3a, 3b are the same in the working example of FIG. 1. However, the vessels 3a, 3b may also have different vessel volumes V₁, V₂. The vessel 3a is connected to the vessel 3b via a connecting conduit 5 in flow connection. In this way, in the arrangement 10, when loaded with a liquid, a system of two vessels 3a, 3b in communication for a liquid is implemented. In this case, a vessel design is provided and adjusted to a standard fill level N at which, at the same design pressure pr in both vessels 3a, 3b, the same fill level is also established in both vessels 3a, 3b at the predefined design fill level N. This is achieved in that the vessels 3a, 3b are at the same height. Furthermore, a first product flow conduit 17 enters the vessel 3a and a second product flow conduit 19 enters the vessel 3b. The openings are above the design fill level N. A float device 7 with a float element is present in both vessels 3a, 3b, such that, in normal operation, a current measurement of the respective fill level in the vessels 3a, 3b is possible. A pressure differential Δp between the vessels 3a, 3b results in a proportional height differential Δh of the liquid. At the design pressure pr and the design fill level N in the first gas separator 1 and in the second gas separator 2, the pressure differential Δp=0 mbar. For normal operation, a pressure differential Δp of not more than about 100 mbar is provided and permissible, such that, because of the pressure differential Δp, a corresponding permissible difference Δh in the fill level of the vessels 3a, 3b is established.

The arrangement 10 is designed such that, at the same working pressure, at a design pressure pr in the vessels 3a, 3b, the predefined standard fill level N of the liquid is established, such that, at the standard fill level N, a liquid volume V_{F1} is provided in the first vessel 3a and a liquid volume V_{F2} in the second vessel 3b. The vessel volume V₁of the vessel 3a is the product of adding the liquid volume V_{F1} and the corresponding gas volume V_{G1}. Correspondingly, the vessel volume V₂ of the vessel 3b is the product of adding the liquid volume V_{F2} and the corresponding gas volume V_{G2}. The vessels 3a, 3b are conceived and designed for operation in such a way that, under normal operating conditions, at a design pressure p_{N} and at a pressure differential Δp=0 mbar, at the standard fill level N in both vessels 3a, 3b, the liquid volume V_{F1}, V_{F2} is greater than the corresponding gas volume V_{G1}, V_{G2}. It has been found in design situations close to reality that, at the standard fill level N of the two vessels 3a, 3b, the liquid volume V_{F1}, V_{F2} is typically greater than the gas volume V_{G1}, V_{G2} by at least 10%, in particular by 15% to 30%. Depending on the application and safety requirements, it is alternatively possible to employ larger safety reserves, i.e. differences in volume between liquid volumes V_{F1}, V_{F2} and gas volumes V_{G1}, V_{G2} of vessels 3a, 3b. Corresponding fill level sensors for the standard fill level and for the permissible differences not shown in detail in FIG. 1—may be mounted at the appropriate height on vessels 3a, 3b.

The respective gas-liquid mixture is fed in operation via the first product flow conduit 17 to the first gas separator 1 or via the product flow conduit 19 to the second gas separator 2 for the respective phase separation. For example, the first gas may be hydrogen H₂ and the second gas may be oxygen O₂, which are obtained from an upstream electrolysis process in a gas-water mixture H₂/H₂O or O₂/H₂O and separated from the water by means of the arrangement 10. Accordingly, the first and second gas separated in each case from the liquid is taken from the vessels 3a, 3b via a respective gas outlet conduit 23 and passed onward for further treatment and processing, for instance a gas purification. In order to ensure a high intrinsic safety of the arrangement 10, in particular with regard to explosion protection and impermissible mixing of the reactive gases, an activatable valve 9 is installed in each case in the arrangement 10 in the gas outlet conduit 23 immediately above the vessels 3a, 3b on the top thereof. In the event of an impermissibly high pressure differential Δp between the vessels 3a, 3b above a permissible maximum pressure differential Δpₘₐₓ, the corresponding valve 9 is activated and closed by the float device 9, depending on the pressure gradient. It is also possible here that the valve 9 is designed as a throttle valve, such that a predefined reduced volume flow rate of the liquid or the gas-liquid mixture can pass through the gas outlet conduit 23. Additionally introduced into the gas outlet conduit 23 downstream of the valve 9 is a cyclone separator 11, such that, in an emergency situation, in the event of a breakthrough of the gas or the gas-liquid mixture from one of the vessels 3a, 3b, a phase separation of liquid and gaseous phase outside the vessel 3a, 3b itself too is still possible and ensured. The liquid, for example water H₂O or an alkaline aqueous solution, can be introduced into a collecting vessel 13 connected downstream of the cyclone separator 11. It is also possible that, in an advantageous modification of the vessel arrangement shown in FIG. 1, a respective collecting vessel 13 is connected downstream of the vessel 3a and the vessel 3b, such that, in that case, separate collection of the respective liquid in a respective collecting vessel 13 is envisaged. It is also possible here that the two respective collection volumes are structurally implemented by means of a dividing wall in one and the same collecting vessel 13. The first gas, for example hydrogen H₂, and the second gas, for example oxygen O₂, are thus removable separately via a respective conduit 25 without any risk of a hazardous explosive gas mixture. In addition to the function of an emergency activation for the valve 9 in normal operation, the float device 9 can also serve as an element of fill level measurement and monitoring within the scope of the predefined permissible pressure differential Δp or corresponding height differential Δh. The measurement signal can be processed in a fill level controller—not shown in detail in FIG. 1—and the fill level controller can initiate, if necessary, a control intervention in the operation of the arrangement 10.

Operation with use of the arrangement 10 in association with an upstream process intrinsically ensures and achieves the effect that the fill level in a vessel 3a, 3b, at design pressure p_{N}, is set to a standard fill level N, where gas transfer between the vessels 3a, 3b is reliably prevented in the case of a high pressure differential Δp above a maximum permissible pressure differential Δpₘₐₓ, so as to stop the first gas from mixing with the second gas. This prevents the formation of explosive gas mixtures. Thus, the procedure of separation, treatment and processing of reactive process gases with the arrangement 10 effectively counters ignition or any risk of explosion, since formation of gas mixtures is avoided with the arrangement 10.

FIG. 2 shows a simplified diagram of an electrolysis plant 20 in which an electrolyzer 15 is connected to an arrangement 10 according to FIG. 1 and is fully integrated into the electrolysis plant 20. The vessels 3a, 3b have the same vessel volume V₁, V₂, and the vessels 3 a, 3 b are in hydraulic communicating connection for a liquid via the connecting conduit 5 and are at the same height. In this example, the industrial process upstream of the arrangement 10 is an alkaline electrolysis in which the electrolyzer 15 is supplied with an alkaline aqueous solution as reactant, in particular potassium hydroxide KOH in an aqueous solution with a concentration of 20%-40%. Product gases produced from the electrochemical decomposition of concentrated potassium hydroxide are hydrogen H₂ as the first gas and oxygen O₂ as the second gas. The electrolyzer 15 generally has a plurality of electrolysis cells that are not shown in detail in FIG. 2, and are arranged adjacent to one another or stacked in what is called an electrolysis stack. In the electrolysis stack, which is under a DC voltage, the reactant introduced in an alkaline electrolysis is concentrated potassium hydroxide KOH in corresponding aqueous solution in H₂O, where two fluid streams consisting of water H₂O and gas bubbles of oxygen O₂ or hydrogen H₂ exit in a respective phase mixture after passing through the electrolysis cells.

In alkaline water electrolysis in potassium hydroxide solution, water H₂O as reactant is electrochemically decomposed to an oxygen product gas O₂ and a hydrogen product gas H₂. For the electrochemical decomposition, the electrolysis plant 20 includes the electrolyzer 15. The electrolysis plant 20 also has a first gas separator 1 on the hydrogen side and a second gas separator 2 on the oxygen side. The electrolyzer 15 is connected to the first gas separation device 1 via a first product stream conduit 17 and to the second gas separation device 2 via a second product stream conduit 17. Each gas separator 1, 2 has a respective vessel 3a, 3b, which are characterized by equal vessel volumes V₁, V₂. Accordingly, a phase mixture composed of water H₂O and hydrogen H₂ is transported via the first product stream conduit 17. A phase mixture composed of water H₂O and oxygen O₂ is conducted out of the electrolyzer 15 through the second product stream conduit 19. Subsequently, in the respective gas separator 1, 2, a separation of the liquid—in this case potassium hydroxide solution—from the respective product gas takes place.

In addition, the potassium hydroxide solution H₂O/KOH is returned to the electrolyzer 15 from the second gas separator 2 via a connecting conduit 5. The potassium hydroxide solution H₂O/KOH from the first gas separator 1 is introduced via the connecting conduit 5 into a supply conduit 27 of the electrolyzer 15. The connecting conduit 5 from the first gas separator 1 and the second gas separator 2 each open into a mixing device 29, and so the liquids are combined and mixed. The mixing achieves controlled balancing of the concentration of the potassium hydroxide solution and heat balancing. It is also possible that the function of a heat exchanger is additionally implemented in the mixing device 29, which is not shown in detail in FIG. 2. This allows the temperature of the alkali to be adjusted to a predefined value by transferring heat to a heat exchange medium. In particular, this means that the excess process heat can be removed from the electrolysis plant 20 by the electrolysis and can be utilized in other process steps if required.

Fresh reactant liquid, in particular water H₂O or, if required, concentrated potassium hydroxide H₂O/KOH in the case of an alkaline electrolysis are supplied via the feed conduit 21. As a result, the consumption of reactant liquid is continuously compensated and in normal operation regulated to a standard fill level N in the vessels 3a, 3b by means of a fill level controller. The fill level in a vessel 3a, 3b is adjusted and regulated to a standard fill level N in accordance with the elucidations relating to FIG. 1, where gas transfer between the vessels 3a, 3b is prevented in the case of a high pressure differential Δp above a maximum permissible pressure differential Δpₘₐₓ, so as to stop the first gas—in this case hydrogen H₂—from mixing with the second gas—in this case oxygen O₂. This purpose is served by a float device (7) disposed on top of the vessel 3a, 3b in each case at its gas outlet, such that, in the event of a high pressure differential Δp above a maximum permissible pressure differential Δpₘₐₓ, liquid is prevented from exiting from a gas separator 1, 2 or the volume flow rate is throttled to a set value. The vessel is designed such that, at the same pressure—the design pressure p_{N}—in the vessels 3a, 3b, the predefined standard fill level N of the liquid is established. At the standard fill level N, a liquid volume V_{F1}, V_{F2} is provided, where the vessel volume V₁, V₂ is composed of the liquid volume V_{F1}, V_{F2} and the corresponding gas volume V_{G1}, V_{G2}. The chosen liquid volume V_{F1}, V_{F2} in the vessels 3a, 3b is greater than the corresponding gas volume V_{G1}, V_{G2}; the liquid volume V_{F1}, V_{F2} in the vessels 3a, 3b is typically at least 10% to 15% greater than the gas volume V_{G1}, V_{G2}, whereby a sufficient safety reserve is provided.

A further feature of the safety concept is that a cyclone separator 11 is additionally connected in each case to the gas outlet conduit 23 of the vessels 3a, 3b. Even in the event of breakthrough of the gas from one of the vessels 3a, 3b, a phase separation of liquid and gas is thus performable outside the gas separator 1, 2. The gas component separated from the phase mixture is discharged from the cyclone separator 11 via a respective conduit 25 and can be sent to further use. The liquid component H₂O/KOH separated from the phase mixture can be introduced into a collecting vessel 13, collected there and stored safely.

It may also be the case here that, in an advantageous modification of the vessel arrangement shown in FIG. 2, a respective collection vessel 13 is connected downstream of the vessel 3a and the vessel 3b, such that, in that case, separate collection of the respective liquid in a respective collection vessel 13 is envisaged. It is also possible here that the two respective collection volumes are structurally implemented by means of a dividing wall in one and the same collecting vessel 13.

As a result, an operational safety concept is implemented in an electrolysis plant 20 such that gas breakthrough and hazardous gas transfer are already intrinsically ruled out by the plant design. Any risk of explosion through mixing of reactive gases such as oxygen O₂ and hydrogen H₂ is thus also avoided. The electrolyzer 15 is connected on the reactant side to the connecting conduit 5 of the arrangement 10 such that a reactant liquid, for example an alkaline aqueous concentrated KOH solution, is available in operation in the anode chamber and in the cathode chamber of the electrolysis cell or flows through these reaction chambers. Moreover, fresh reactant liquid can be fed continuously to the electrolyzer 15 via a supply conduit 21 in order to compensate for the consumption of water or electrolyte solution in normal operation and for adjustment to the standard fill level N or for maintenance of the mode of operation at the standard fill level N.

1-12. (canceled)

13. An electrolyzer for production of hydrogen and oxygen as product gases, the electrolyzer comprising:
an arrangement for gas-liquid separation, said arrangement including:
a first gas separator for a first gas and a second gas separator for a second gas, each of said first and second gas separators having a respective vessel, said vessels each having a respective vessel volume and said vessels being at the same height, and a connecting conduit, said vessels being in hydraulic communicating connection for a liquid through said connecting conduit;
a first product flow conduit for hydrogen being connected to said first gas separator and a second product flow conduit for oxygen being connected to said second gas separator; and
a fill level controller providing closed-loop control to a predefined standard fill level in said vessels for establishing the predefined standard fill level of the liquid when a pressure in said vessels is equal, and providing a liquid volume at the standard fill level;
the vessel volume being composed of the liquid volume and a corresponding gas volume, and the liquid volume in said vessels being greater than the corresponding gas volume.

14. The electrolyzer according to claim 13, wherein said fill level controller is configured to provide the liquid volume at least 10% greater than the gas volume, at the predefined standard fill level of said first and second vessels.

15. The electrolyzer according to claim 13, wherein said fill level controller is configured to provide the liquid volume 15% to 30% greater than the gas volume, at the predefined standard fill level of said first and second vessels.

16. The electrolyzer according to claim 13, wherein said fill level controller in said arrangement is configured for normal operation at a nominal pressure with a pressure differential of not more than 100 mbar between gas phases in said vessels.

17. The electrolyzer according to claim 13, wherein one of said vessels in said arrangement has a valve disposed on top of said vessel at a gas outlet and a float device activating said valve, for preventing liquid from exiting from said gas separator or throttling a volume flow rate to a set value, in an event of a high pressure differential above a maximum permissible pressure differential.

18. The electrolyzer according to claim 17, wherein said float device has an electrical fill level measuring device configured to bring about electrical activation of said valve.

19. The electrolyzer according to claim 16, wherein said valve is a throttle valve configured to be activated to reduce the volume flow of the liquid to less than 50%.

20. The electrolyzer according to claim 19, wherein said throttle valve is configured to be activated to reduce the volume flow of the liquid to less than 20%.

21. The electrolyzer according to claim 13, wherein said arrangement has at least one cyclone separator disposed downstream of said gas separators at a gas outlet, for bringing about a phase separation of liquid and gas outside said gas separators in an event of a breakthrough of the gas from one of said vessels.

22. The electrolyzer according to claim 19, which further comprises a collecting vessel downstream of said at least one cyclone separator, for introducing liquid separated off in said at least one cyclone separator into said collecting vessel.

23. A method of operating an electrolyzer, the method comprising:
providing the electrolyzer according to claim 13;
adjusting the fill level in one of said vessels to the standard fill level; and
preventing gas transfer between said vessels when a high pressure differential is above a maximum permissible pressure differential, to stop the first gas from mixing with the second gas.

24. The method according to claim 23, which further comprises supplying the electrolyzer with a liquid as a reactant, producing product gases as hydrogen being the first gas and oxygen being the second gas by electro-chemical decomposition in a respective phase mixture, and conducting a gas-liquid separation of the product gases in said gas separators.

25. The method according to claim 24, which further comprises supplying the electrolyzer with an alkaline aqueous solution as the reactant.

26. The method according to claim 25, which further comprises providing as the reactant potassium hydroxide in an aqueous solution with a concentration of 20%-40%.

27. An electrolysis plant, comprising the electrolyzer according to claim 13.
